(19) United States
(12) Patent Application Publication
(10) Pub. No.: US 2024/0129599 A1
(43) Pub. Date: Apr. 18, 2024

(54) SYSTEMS AND METHODS FOR GENERATING OVERLAYS FOR A BROADCAST

(71) Applicant: INTANEOUS LLC, Los Angeles, CA (US)

(72) Inventors: Gregory BASSER, Fitzroy, Victoria (AU); Andrew John MARRIOTT, Higgins, Australian Capital Territory (AU); Christopher Lance CAIRNS, O'Connor, Australian Capital Territory (AU); David Blyth HILL, Pacific Palisades, CA (US); David ANTON, New York, NY (US)

(21) Appl. No.: 18/546,356

(22) PCT Filed: Feb. 11, 2022
(86) PCT No.: PCT/IB2022/051222

§ 371 Date: Aug. 14, 2023

Related U.S. Application Data
(60) Provisional application No. 63/200,091, filed on Feb. 12, 2021.

(51) Int. Cl. H04N 21/81; H04N 21/2187; H04N 21/234

(52) U.S. Cl. CPC H04N 21/8146; H04N 21/2187; H04N 21/23418

(57) ABSTRACT

Some embodiments relate to methods, systems and computer-readable media for generating overlay graphics for a broadcast transmission or generating broadcast augmentation instructions. An example method comprises: receiving a broadcast transmission stream of an event from a camera, the broadcast transmission stream comprising a series of images; receiving a stream of event data corresponding to the series of images, the stream of event data comprising object information regarding an object in the series of images; defining an overlay element based on the stream of event data, the overlay element being associated with the object in the series of images; augmenting the broadcast transmission with the overlay element to generate an augmented broadcast transmission, the augmented broadcast transmission comprising the series of images overlayed with the overlay element. A latency between receiving the broadcast transmission stream and generating the augmented broadcast transmission is designed to be imperceptible to the human eye.

### TECHNICAL FIELD

The disclosure relates to systems and methods for generating overlays for broadcast transmissions. In particular, the disclosure relates to image and sensor data processing techniques and systems for generating graphical overlays for broadcast transmissions using augmented reality production techniques.

### BACKGROUND

Coverage of events such as sporting events is routinely broadcast to a wide-ranging audience through a television broadcast or through online streaming. Sporting events are captured by a wide variety of information monitoring systems or devices. Such systems or devices may include multiple high-resolution video cameras, sensors placed in sports objects, sensors in parts of the sporting venue, sensors on or in sporting equipment or sensors on players themselves, for example. Therefore, as a sporting event unfolds, a large volume of data can be continuously generated by a myriad of sensors and cameras. Embedded in the large volume of data from different sources is information regarding the various sporting events or occurrence of events during the course of play. Information embedded in the large volume of data may be useful for making broadcasts of sporting events more information-rich, accurate and easy to perceive.

Any discussion of documents, acts, materials, devices, articles or other similar content which has been included in the present specification is not to be taken as an admission that any or all of these matters form part of the prior art base or were common general knowledge in the field relevant to the present disclosure as it existed before the priority date of each claim of this application.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### SUMMARY

Some embodiments relate to a method for generating overlay graphics for a broadcast transmission, the method comprising: receiving a broadcast transmission stream of an event from a camera, the broadcast transmission stream comprising a series of images; receiving a stream of event data corresponding to the series of images, the stream of event data comprising object information regarding an object in the series of images; defining an overlay element based on the stream of event data, the overlay element being associated with the object in the series of images; augmenting the broadcast transmission with the overlay element to generate an augmented broadcast transmission, the augmented broadcast transmission comprising the series of images overlayed with the overlay element; wherein a latency between receiving the broadcast transmission stream and generating the augmented broadcast transmission is imperceptible to the human eye.

The method of some embodiments further comprises receiving a camera sensor data stream corresponding to the camera, the camera sensor data stream comprising camera position, orientation and focus data.

In some embodiments, generating the augmented broadcast transmission is based on processing the camera sensor data stream to simulate a virtual camera in a virtual model of the event venue using the camera sensor data stream.

The method of some embodiments further comprises processing the stream of event data to filter event data and to select event data relevant to the definition of the overlay element.

The method of some embodiments further comprises processing the stream of event data to determine an object attribute.

The object attribute may comprise any one or more of: an object position information within the virtual model of an event venue, or an object velocity, or an object orientation.

The determined object attribute may comprise a projected object path in the event venue.

In some embodiments, the overlay element is generated based on the determined object attributes and a predefined trigger condition. The predefined trigger condition may comprise a threshold relating to the object attribute to determine the generation of the overlay element.

The method of some embodiments further comprises processing the series of images to determine a foreground object in the series of images.

In some embodiments, defining the overlay element based on the stream of event data further comprises determining whether the overlay element obfuscates the foreground object in the series of images, on determining that the overlay element obfuscates the foreground object in the series of images, modifying the overlay element to not obfuscate the foreground object. The foreground object may comprise a person or a venue artefact.

In some embodiments, defining the overlay element based on the stream of event data further comprises determining a display position of the overlay element within the series of images, wherein the display position is based on the determined object attribute.

The object may include any one of: a sports projectile, a person, or a venue artefact.

In some embodiments, the processing of the stream of event data to determine the object attribute and the simulation of the virtual camera is performed in parallel.

In some embodiments, the augmenting of the broadcast transmission with the overlay element is performed by a graphics rendering engine.

In some embodiments, determination of foreground objects in the series of images is performed using matting image processing operations.

Some embodiments relate to a method for generating broadcast augmentation instructions, the method comprising: receiving a stream of event data corresponding to a series of images in a broadcast transmission stream, the stream of event data comprising object information regarding an object in the series of images; receiving a camera sensor data stream corresponding to a camera, the camera sensor data stream comprising data defining a camera position, a camera orientation and camera focus data; processing the stream of event data using a set of rules to trigger an overlay element definition; generating broadcast augmentation instructions suitable for a graphics rendering engine, the broadcast augmentation instructions comprising instructions based on the overlay element definition; wherein a latency between receiving the stream of event data and transmitting the broadcast augmentation instructions is imperceptible to the human eye.

Some embodiments relate to a method for generating overlays for broadcast transmission, the method comprising: receiving a broadcast transmission stream of an event from a camera, the broadcast transmission stream comprising a series of images; receiving a stream of event data corresponding to the series of images, the stream of event data comprising object information regarding an object in the series of images; defining an overlay element based on the stream of event data, overlay element being associated with the object in the series of images; augmenting the broadcast transmission with the overlay element to generate an augmented broadcast transmission, the augmented broadcast transmission comprising the series of images composited with the overlay element; wherein a latency between receiving the broadcast transmission stream and generating the augmented broadcast transmission is in the range of 20 ms to 120 ms.

Some embodiments relate to a method for generating overlays for broadcast transmission, the method comprising: receiving a broadcast transmission stream of an event from a camera, the broadcast transmission stream comprising a series of images; receiving broadcast augmentation instructions, the broadcast augmentation instructions comprising an overlay element definition; generating overlay element graphics based on the overlay element definition; compositing the generated overlay element graphics with the series of images to generate an augmented broadcast transmission; wherein a latency between receiving the broadcast transmission stream and generate the augmented broadcast transmission is imperceptible to the human eye.

Some embodiments relate to a system for generating overlays for broadcast transmission, the system comprising: at least one processor in communication with a memory; the memory comprising program code executable by the processor to: receive a stream of event data corresponding to the series of images, the stream of event data comprising object information regarding an object in the series of images; define an overlay element based on the stream of event data, the overlay element being associated with the object in the series of images; generate broadcast augmentation instructions based on the defined overlay element; wherein a latency between receiving the stream of event data and generating broadcast augmentation instructions is imperceptible to the human eye.

Some embodiments relate to a system for generating broadcast augmentation instructions, the system comprising: at least one processor in communication with a memory; the memory comprising program code executable by the processor to: receive a stream of event data corresponding to a series of images in a broadcast transmission stream, the stream of event data comprising object information regarding an object in the series of images; receive a camera sensor data stream corresponding to a camera, the camera sensor data stream comprising data defining a camera position, a camera orientation and camera focus data; process the stream of event data using a set of rules to trigger an overlay element definition; generate broadcast augmentation instructions suitable for a graphics rendering engine, the broadcast augmentation instructions comprising instructions based on the overlay element definition; wherein a latency between receiving the stream of event data and transmitting the broadcast augmentation instructions is imperceptible to the human eye.

Some embodiments relate to a system for generating overlays for broadcast transmission, the system comprising: at least one processor in communication with a memory; the memory comprising program code executable by the processor to: receive a broadcast transmission stream of an event from a camera, the broadcast transmission stream comprising a series of images; receive a stream of event data corresponding to the series of images, the stream of event data comprising object information regarding an object in the series of images; define an overlay element based on the stream of event data, overlay element being associated with the object in the series of images; augment the broadcast transmission with the overlay element to generate an augmented broadcast transmission, the augmented broadcast transmission comprising the series of images composited with the overlay element; wherein a latency between receiving the broadcast transmission stream and generating the augmented broadcast transmission is in the range of 20 ms to 120 ms.

Some embodiments relate to a system for generating overlays for broadcast transmission, the system comprising: at least one processor in communication with a memory; the memory comprising program code executable by the processor to: receive a broadcast transmission stream of an event from a camera, the broadcast transmission stream comprising a series of images; receive broadcast augmentation instructions, the broadcast augmentation instructions comprising an overlay element definition; generate overlay element graphics based on the overlay element definition; composite the generated overlay element graphics with the series of images to generate an augmented broadcast transmission; wherein a latency between receiving the broadcast transmission stream and generate the augmented broadcast transmission is imperceptible to the human eye.

Some embodiments relate to a computer-readable storage media comprising program code which, when executed by a computer processor, causes the computer processor to perform a method for generating overlay graphics for a broadcast transmission or a method for generating broadcast augmentation instructions according to the embodiments.

### BRIEF DESCRIPTION OF FIGURES

FIG. 1 illustrates a system for generating overlays for a broadcast according to some embodiments;

FIG. 2 illustrates part of the system of FIG. 1 in further detail;

FIG. 3 illustrates a flowchart for a method of processing an event data stream according to some embodiments;

FIG. 4 illustrates a flowchart for a method of generating overlay graphic augmentation instructions according to some embodiments;

FIG. 5 illustrates a flowchart for a method of generating an augmented broadcast account to some embodiments;

FIG. 6 illustrates a latency timing diagram of generating overlays for a broadcast according to some embodiments;

FIG. 7 is a dataflow diagram showing the path of data streams as they are processed by the various logical and physical components of the system for generating overlays for a broadcast according to some embodiments; and

FIGS. 8 to 12 are example augmented broadcast images generated according to some embodiments;

FIG. 13 is an example of an image from an unaugmented video stream according to some embodiments;

FIG. 14 is an example of overlay graphics generated based on event data associated with events associated with the image of FIG. 13 according to some embodiments;

FIG. 15 is an image generated by performing a matting image processing operation on the image of FIG. 13; and

FIG. 16 is an image generated by compositing the overlay graphics of FIG. 14 in the image of FIG. 13.

### DETAILED DESCRIPTION

The described embodiments relate to methods and systems for generating overlays for broadcast transmissions. In particular, the embodiments relate to methods and systems incorporating elements of image processing for virtual image augmentation, object detection, motion detection, kinetics, camera sensor data processing and visual effect production to generate augmented broadcasts of events. In some embodiments, the generated augmented broadcasts may relate to live events. In some embodiments, the generated augmented broadcasts may relate to non-live events or replays of events. Events may include sporting events for sports such as tennis, cricket, golf, football, motorsport racing, volleyball, basketball, baseball, rugby, ice hockey, horse racing, hockey, badminton, snooker, boxing, martial arts, chess for example. This list of sporting events is non-limiting and the embodiments may be applied to other suitable sporting events or competitions or board games or card games, for example.

Conventional event broadcasts comprise a video stream of the event. Conventional broadcasts may comprise graphical elements such as scorecards, markers, or hand-drawn overlays by commentators to enhance the information regarding the event presented to viewers. However, such graphical elements are either pre-prepared, subject to significant (10+ second) delays and/or not a direct consequence or response to what is shown in the live broadcast.

The described embodiments allow for automatic generation of overlay graphics on broadcasts based on images captured by cameras, event data generated based on images captured by cameras or sensors incorporated in the event venue, and virtual image augmentation techniques. Embodiments described herein allow for the generation of the overlays in near-real-time or with a latency imperceptible or barely noticeable to the human eye. In the context of the present application, the term “near-real-time” is used to convey that, although there may be a slight delay between when an event occurs and when the generated overlay is provided for display over the broadcast images of the event, the delay is so slight as to be imperceptible or barely perceptible to the human eye. For example, such delay may be less than 0.15 seconds. In embodiments described herein, the delay (latency) may be between 0.12 seconds and 0.02 seconds, and in some embodiments may be around 0.06 seconds. Accordingly, the embodiments are configured to optimise the virtual image augmentation processes to be computationally efficient while processing the significant volume of data being generated in relation to an event such as a sporting event.

The generated overlays may comprise curves, patterns, textures, lines, text, imagery, projected motion paths or transitional visual effects to augment or enhance the information presented during a broadcast. For example, for a broadcast of a game of tennis, overlay graphics may include highlighting of a court marking close to which the ball lands. If a ball lands outside a court marking, then the court marking or a nearby area may be overlayed with a graphic, such as a red highlight, to indicate the ball landed outside the marking. Similarly, if a ball lands on or inside a court marking, then the court marking or a nearby area may be overlayed with a different graphic, such as a green highlight, to indicate the ball being in bounds, such that it is validly served or returned.

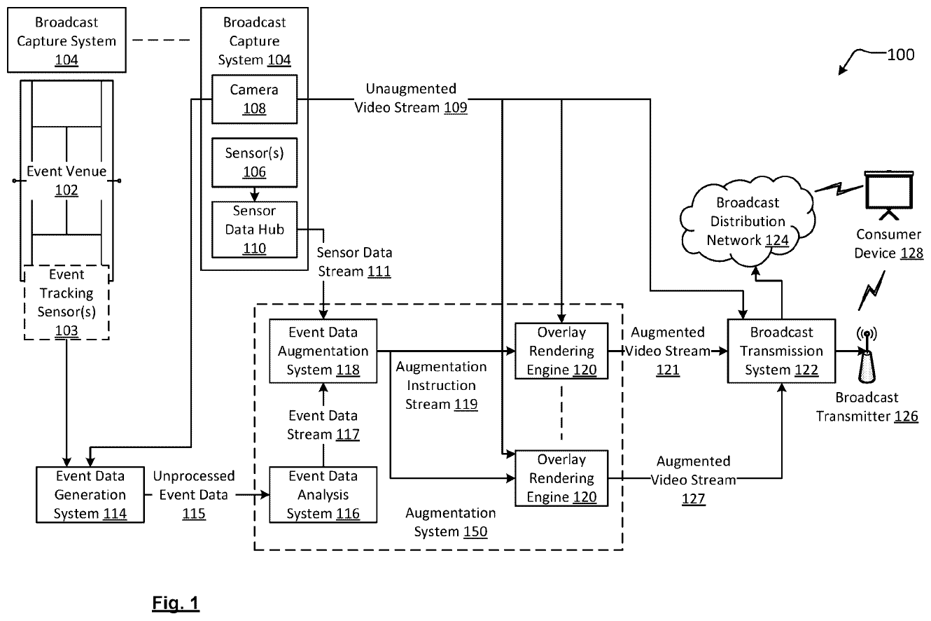

FIG. 1 illustrates a broadcast overlay generation system 100 according to some embodiments. Item 102 relates to a schematic representation of an event venue. The event venue 102 may be any venue suitable for a competition such as a sporting competition. Venue 102, depending on the kind of competition or sport, may have a predefined structure and orientation identified by one or more physical areas or markings on a ground or floor or other static surface or surfaces. Venue 102 may also have one or more static venue artefacts. For example, if venue 102 is or includes a tennis court, it comprises a net of a predefined height at a particular position in the venue 102. Similarly, if venue 102 is or includes a football ground, then venue 102 may comprise two goal areas, each goal area defined by markings and/or two or more goal posts. Similarly, if venue 102 is or includes a track for motorsport, it may comprise track markings defining the race path or other markings. The structure of the event venue 102 may be represented in a virtual 3D model to allow simulation of camera positions within the event venue 102 to enable generation of overlay graphics or overlay elements. The virtual 3D model of the event venue 102 may also allow determination of the position of game objects with respect to the various physical markings or the various artefacts in the event venue 102.

Broadcast capture system 104 comprises elements to capture events occurring in the event venue. The broadcast capture system 104 comprises a camera 108, at least one sensor 106 and a sensor data hub 110. Some embodiments may comprise more than one broadcast capture system 104, with the camera 108 of each distinct broadcast capture system 104 positioned to capture images of the event venue 102 from different perspectives. The camera 108 may be or include a high-resolution broadcast capture camera, configured to capture a series of images and sounds of the events occurring in the event venue 102. Sensor 106 may capture the various configuration parameters of the camera 108. In some embodiments, sensor 106 may be a part of the camera. In some embodiments, sensor 106 may be positioned on a head or a mounting system of camera 108 and may be configured to communicate with camera 108 to capture the various configuration parameters of camera 108. In some embodiments, sensor 106 may comprise one or more lens data encoders to obtain, encode and generate a stream of data associated with a lens of the camera 108. The lens data may include data regarding lens position, focus position, focal length, and/or focal distance, for example. Sensor 106 may also capture position and orientation information of the camera 108. Position information regarding camera 108 includes information regarding the relative position of camera 108 with respect to the virtual model of the event venue 102. The position information may be represented in the form a 3D coordinate of the camera 108 within the virtual model of the event venue 102. Orientation information regarding camera 108 includes information regarding the line of sight of camera 108. Orientation information regarding camera 108 may be represented using a combination of the position information and angles corresponding to the line of sight of camera 108, camera pan information, camera tilt information, crane pan information, crane tilt information, and/or camera dolly position, for example.

During the course of the events in the event venue 102, camera 108 may be moved around and its line of sight or focus position may change. As the configuration of camera 108 changes to respond to events occurring in the event venue 102, sensor 106 dynamically captures the changing camera configuration and generates in real-time one or more streams of data corresponding to the camera configuration.

The sensor 106 may generate data at the same frequency as the frequency of images captured by camera 108. Accordingly, for each frame of images generated by camera 108, there may be a corresponding synchronous camera configuration data packet generated by sensor 106. In some embodiments, the sensor 106 may generate data packets asynchronously in immediate response to actual changes in the configuration of camera 108. In some embodiments, one or more camera tracking sensors provided by Cartoni™, Vinten™, Mo-SYS™, stYpe™ or Ncam™ may be used as sensor 106, for example.

Multiple broadcast capture systems 104 may be positioned in or around an event venue 102 to capture data regarding events occurring in the event venue. In some embodiments, 30 or more broadcast capture systems 104 may be deployed to capture data regarding events occurring in the event venue 102. Each broadcast capture system 104 may be positioned in a different location in or around the event venue 102 to capture event data from a different perspective. The information generated by sensors 106 may be transmitted through a sensor data hub or gateway 110. Sensor 106 may be connected to the sensor data hub 110 using a suitable communication cable. The sensor data hub 110 collates or channelizes all the sensor data from the sensor 106 of its respective broadcast capture system 104. Each sensor data hub 110 transmits the collated sensor data to an event data augmentation system 110 in a sensor data stream 111. In some embodiments, the sensor data stream 111 may be transmitted using a wired communication link such as an RS232 or an RS422 connection link. In other embodiments, the sensor data stream 111 may be transmitted over a high-speed wireless communication link such as a high-speed radio communication link or a Wi-Fi™ communication link, for example. In some embodiments, the sensor data stream 111 may be transmitted using a combination of wired and wireless communication links.

System 100 includes and/or receives event data from an event data generation system 114 is a system that generates data regarding events occurring in the event venue 102. The specific events and the related event data may vary depending on the kind of event or sport occurring in the event venue 102. For example, for a game of tennis, event data may comprise position information of a centroid of a tennis ball at a particular point in time and position information of each player at a particular point in time. Similarly, for a motorsport race, event data may comprise position information of a centroid or other feature or characteristic of a vehicle at a particular point in time and position information of each vehicle at a particular point in time. The player and/or object position information may be represented using 3D coordinates defined with respect to the virtual 3D model of the event venue 102. In some embodiments, third party event generation systems such as Hawk-Eye™ or Virtual Eye™ may be used.

In some embodiments, event tracking sensors 103 may be provided in the event venue 102. The event tracking sensors 103 may be mounted on fixtures or objects within or around the event venue 102 or they may be mounted on players or referees or sports equipment in the event venue 102, for example. The event tracking sensors 103 may include optical sensors, accelerometers, time of flight sensors, range imaging sensors, audio sensors, impact sensors for example. The event data generation system 114 may take into account event sensor data generated by the event tracking sensors 103 to generate a stream of unprocessed event data 115. In some embodiments, the event data generation system 114 may also generate event data based on images captured by camera(s) 108. The stream of unprocessed event data may include data regarding position or orientation of one or more objects in the event venue 102, the position of one or more players within the event venue 102, a projected path of an object or a player within the event venue 102, for example.

The unprocessed event data 115 may be generated with a latency of around 5 ms to 80 ms or more after the occurrence of an event on the event venue 102, for example. The unprocessed event data 115 may be generated with a frequency of 50 Hz or more, for example. As the unprocessed event data 115 is generated at relatively low latency and high frequency, the unprocessed event data 115 may comprise one or more errors. The unprocessed event data 115 may be transmitted by the event data generation system 114 to an augmentation system 150 using the TCP/IP (Transmission Control Protocol/Internet Protocol) communication protocol. In some embodiments, the event data generation system 114 may comprise one or more subsystems, with some subsystems being positioned in or in proximity to the event venue 102 and rest of the subsystems located away from the event venue 102, such as in a cloud computing environment. In some embodiments, the event data generation system 114 may comprise a message queueing components such as RabbitMQ, Apache Kafka, or Amazon MQ, for example. The message queuing components of the event data generation system 114 are configured to allow fast, efficient and low latency retrieval of the unprocessed event data 115 by an event data analysis system 116 of the augmentation system 150. The unprocessed event data 115 may be transmitted using messages packaged using the JSON (JavaScript Object Notation), YAML or XML (Extensible Markup Language) based message interchange formats, for example.

The event data analysis system 116 processes and analyses the unprocessed event data 115 to generate an event data stream 117 that comprises refined, error corrected and/or condensed event data. The event data analysis system 116 may discard unprocessed event data 115 that is received at a higher latency (for example, a latency of greater than 60-80 ms), the latency being measured with respect to the time of actual occurrence of events in the event venue 102. The event data analysis system 116 is configured to process the unprocessed event data 115 that is received at a relatively lower latency (for example, a latency in the range of 5-20 ms) to focus on the most recent events occurring in the event venue 102. The event data stream 117 is provided as an input to an event data augmentation system 118 within the augmentation system 150. The event data augmentation system 118 receives both the sensor data stream 111 from sensor data hub 110 and the event data stream 117 and processes the two data streams to generate an augmentation instruction stream 119.

The augmentation instruction stream 119 comprises instructions for an overlay rendering engine 120. The overlay rendering engine 120 may comprise a 3^{rd} party video rendering engine such as the Unreal Engine™, VizRT™, Pixotope™ or ExpressionEngine rendering engines, or other similar game or video production rendering engines. The rendering engine in the broadcast image overlay rendering engine 120 comprises one or more of: a framework, a software development environment, computer programs, computer program libraries, computer program dependencies, physics engines, and/or relevant application programming interfaces (APIs) to process an unaugmented video stream 109 and based on the augmentation instruction stream 119 generate an augmented video stream 121. The augmented video stream 121 comprises a stream of a series of images that include one or more graphic overlays generated by the overlay rendering engine 120 based on the augmentation instruction stream 119. The augmented video stream 121 may also include audio captured by the broadcast capture system 104.

The augmented video stream 121 may be transmitted to a broadcast transmission system 122 to make the augmented video stream 121 more generally available to viewers. The broadcast transmission system 122 may include one or more components, such as an outside broadcasting system, provided in a production environment, such as a production truck or a production control room, located in close proximity of the event venue 102. The augmented video stream may be transmitted through a broadcast transmitter 126 that may comprise an antenna for transmission of the augmented video stream 121. In some embodiments, the augmented video stream 121 may be transmitted through a broadcast distribution network 124 which may include the internet. A consumer device 128 may be a device having a display, such as a television, an end-user computing device such as a laptop, a tablet, a smartphone or a desktop computer, for example. The consumer device 128 may receive the augmented video stream 121 through the broadcast distribution network 124 or through a transmission initiated by the broadcast transmitter 126 and relayed by a satellite or an intermediate transmission system, for example.

The broadcast overlay generation system 100 processes unprocessed event data 115, sensor data 111, and the unaugmented video stream 109 to generate and transmit the augmented video stream 121. In some embodiments, the broadcast overlay generation system 100 may generate the augmented video stream 121 at a low latency of 20 ms to 120 ms, with the latency being measured with respect to the occurrence of events in the event venue 102. The low latency generation of the augmented video stream allows the broadcast of an augmented video stream 121 of live sports or other live events without a substantial delay. Since live sports rely on the engagement of audience all around the world in near-real-time, the broadcast overlay generation system 100 provides an efficient and low latency technical solution to generate graphical overlays in near real-time in response to events occurring in the event venue 102. The latency of the augmented video stream 121 may be so low that it may be imperceptible to the human eye when compared with an unaugmented video stream 109 when broadcast through identical broadcast channels. In some embodiments, the augmented video stream 121 may be broadcast in near real-time with respect to the events occurring in the event venue 102.

In some embodiments, the event data generation system 114, event data analysis system 116, event data augmentation system 118, broadcast image overlay rendering engine 120 and the broadcast transmission system 122 may be located in, or in close or immediate proximity of, the event venue 102. In some embodiments, all or parts of the sensor data hub 110, event data generation system 114, event data analysis system 116, event data augmentation system 118, broadcast image overlay rendering engine 120 and the broadcast transmission system 122 may be located away from the event venue 102. The parts of the broadcast overlay generation system 100 located away from the event venue 102 may be in communication with rest of the components over high-speed communication channels, such as high-speed internet or high-speed radio communication links, for example.

The event data analysis system 116, event data augmentation system 118 and the overlay rendering engine 120 may be collectively referred to as an augmentation system 150. In some embodiments, the various subcomponents of the augmentation system 150 may be consolidated on a common computer system such as a server with sufficient processing power and network communication capability to perform the augmentation and overlay generation operations with low latency as described herein. In some embodiments, the parts of the augmentation system 150 may be located away from or remote to the event venue 102 with adequate networking capability to receive the various data streams in near real-time from the components located in or in close proximity to the event venue 102.

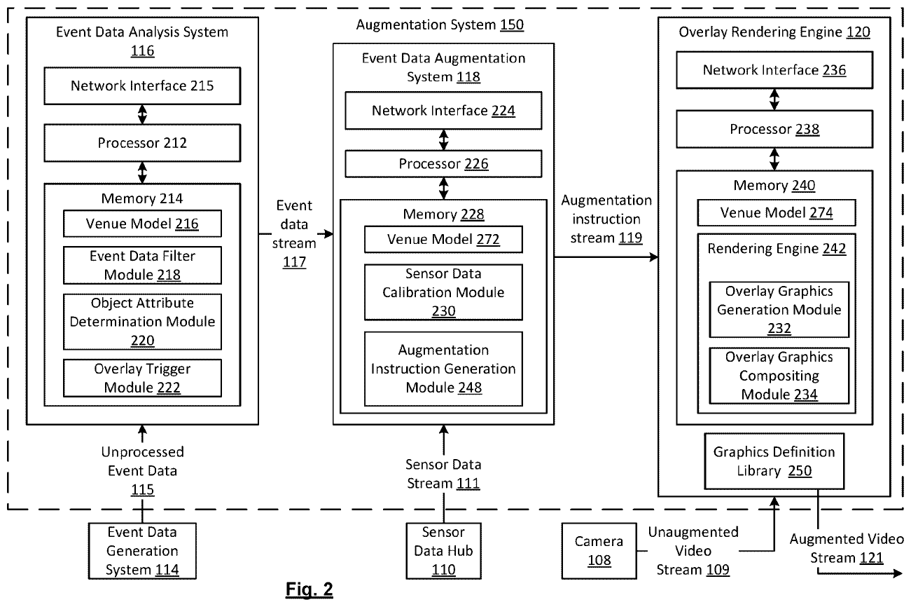

FIG. 2 illustrates a part 200 of the broadcast overlay generation system 100 showing some of the subcomponents in greater detail. The event data analysis system 116 may be implemented using a computing device, a server, a computing appliance or in some embodiments, a server deployed in a cloud computing system, for example. The event data analysis system 116 may be a virtual computer system or a physical computer system or a combination of both. The event data analysis system 116 comprises at least one processor 212 in communication with a memory 214 and a network interface 215. The network interface 215 may comprise hardware or software or a combination of both hardware and software to enable communication with the rest of the components of the broadcast overlay generation system 100. The memory 214 may comprise a combination of volatile and non-volatile memory. Memory 214 comprises program code, program code dependencies, libraries, metadata and APIs to implement the event data analysis processes.

A venue model 216 stored in memory 214 may comprise data regarding a model of the event venue 102. The data comprised in the venue model 216 may allow the simulation of virtual cameras and generation of graphics in visual alignment with the event venue 102. In particular, the venue model 216 may comprise data regarding fixtures and sports artefacts or other event artefacts, plus their locations, position and orientation to allow simulation of the event venue 102 within a computer system. The venue model 216 may comprise data defining a coordinate system to represent various locations in the event venue 102. The coordinate system may be a three-dimensional coordinate system and information regarding objects or players in the event venue 102 may be represented using the coordinate system defined in the venue model 216. The venue model 216 may also comprise information regarding venue artefacts or characteristics, such as location (e.g. GPS coordinate) information, height, width, whether the event venue 102 is open to the air or other salient information, for example.

Memory 214 comprises an event data filter module 218 that comprises program code to process the unprocessed event data stream 115 and filter out irrelevant or unnecessary information in the unprocessed event data stream 115. Filtering the unprocessed event data stream 115 reduces the event data to be processed by subsequent program code modules, leading to a reduction in the overall latency of the analysis of the unprocessed event data 115. For example, for a game of tennis, the unprocessed event data 115 may comprise a data packet for each bounce of the ball. The event data filter module 218 may comprise program code to only take into account a data packet corresponding to a first bounce of the ball during the course of play or a particular game. Eliminating data packets corresponding to subsequent bounces of the ball reduces the volume of unprocessed event data to be considered by the rest of the components of the broadcast overlay generation system 100. With the broadcast overlay generation system 100 generating image overlays at very low latency, small reductions in data to be processed can have an impact on the overall latency of the generation of overlays.

Memory 214 also comprises an object attribute determination module 220. The object attribute determination module 220 comprises program code to determine one or more object attributes based on the filtered event data received from event data filter module 218. The object attributes may relate to position information of an object, or a kinetic attribute of the object, such as speed or velocity, an orientation attribute of the object, or a future or projected position or speed or location of an object, for example. The object attribute may also relate to a player in the event venue 102. Object attributes relating to a player may include a player's location or position, a player's speed or direction of movement, or a player's projected or future position within the event venue 102, for example.

As an example, event data in relation to a game of tennis may include a data packet corresponding to a projected bounce after a hit of the tennis ball. The object attribute determination module 220 may process the data packet corresponding to a projected bounce to determine a projected trajectory or path of the ball and a projected bounce coordinate of the ball with reference to a surface, such as a ground surface, defined by the venue model 216. The determined object attributes may be transmitted to the event data augmentation system 118 to enable the generation of overlay graphics based on the determined object attributes. In some embodiments, the determined object attributes may relate to a projected future event. For example, in some embodiments, the unprocessed event data 115 may comprise data packets regarding a velocity and position of an object such as a ball, or a similar sports projectile. In this scenario, the object attribute determination module 220 may determine a projected trajectory and landing or bounce position or coordinates of the object based on the kinetic principles of projectile motion. Determining information regarding predicted future events allows the event data analysis system 116 to send instructions to the event data augmentation system 118 regarding future events projected to occur in the event venue 102. The determined information regarding projected or future events allows the initiation of the event data augmentation and rendering processes even before the projected event occurs. Therefore, the projected information regarding future events further assists the broadcast overlay generation system 100 in reducing the latency of the generation of the augmented video stream 121.

An overlay trigger module 222 stored in memory 214 comprises program code embodying logic or instructions to identify events in response to which generation of a graphic overlay must occur. The event data generation system 114 may generate unprocessed event data 115 corresponding to a large number and variety of events occurring in the event venue 102. However, not all events occurring in the event venue 102 may be of interest for generating overlays.

For example, for a broadcast of a game of tennis, an overlay pointing to a spot on the court where the ball bounced may be generated only when the ball bounces close to a court marking. The object attribute determination module 220 may comprise program code to determine a distance of the bounce spot or a projected bounce spot of a ball from a court marking. The overlay trigger module 222 may process the determined distance of the bounce spot or a projected bounce spot of a ball from a court marking and, based on a comparison with one or more proximity (distance) thresholds, assess whether the bounce spot is sufficiently close to a court marking to trigger the generation of an overlay.

The program code of the overlay trigger module 222 comprises a set of rules to allow the selection of events suitable for generation of overlays allowing the broadcast overlay generation system 100 to prioritise generation of overlays, thereby improving the latency of the entire system. The trigger conditions or trigger logic or set of rules defining triggers embodied in the overlay trigger module 222 may vary depending on the nature of the events occurring in the event venue. For example, for a broadcast overlay generation system 100 directed to an event venue 102 for a game of football or soccer, the trigger conditions or trigger logic may relate to the proximity of a ball to the goalposts. The trigger conditions or trigger logic may comprise one or more thresholds suitable for comparison with an object attribute determined by the object attribute determination module 220 to determine whether an overlay should be generated in response to an event occurring in the event venue 102.

Various parameters defining the one or more triggers in the program code of the overlay trigger module 222 may be configurable in some embodiments. The configuration of the various parameters defining the one or more triggers may allow definition or calibration of triggers to suit different overlay graphic production needs. Since a significant number of events may occur in the event venue 102, the configuration of the parameters defining the one or more triggers may allow selection of a specific subset of events for the generation of overlay graphics. The various parameters defining the one or more triggers in the program code of the overlay trigger module 222 may be configured using a trigger configuration user interface generated by the overlay trigger module 222 or another program code module of event data analysis system 116. The trigger configuration user interface may be accessible through display and input devices connected to the event data analysis system 116. In some embodiments, a remote end-user computing device such as a desktop device, a laptop device, or a tablet device or a smartphone device may allow access to the trigger configuration user interface through a communication link with the event data analysis system 116. The event data analysis system 116 processes the unprocessed event data 115 to generate a stream of processed event data 117. As described, the processing of the unprocessed event data 115 is performed automatically by the event data analysis system 116. The processed event data stream 117 may be generated with an event data processing latency in the range of 1 ms to 15 ms, for example. The event data stream 117 has substantially less data than the unprocessed event data 115 received by event data analysis system 116 from the event data generation system 114. The event data analysis system 116 may reduce the amount of data by a percentage in the range of 50% to 99%, for example. This substantial reduction in the amount of data by the various filtering, attribute determination and trigger operations allows the rest of the broadcast overlay generation system 100 to efficiently generate broadcast overlay graphics at a low latency.

The event data augmentation system 118 comprises at least one processor 226 in communication with a network interface 224 and a memory 228. Memory 228 comprises program code modules, program code dependencies, libraries, metadata and APIs to process the sensor data stream 111 and the event data stream 117 to generate an augmentation instruction stream 119 to be transmitted to a broadcast overlay rendering engine 120. Memory 228 may also store the venue model 272 that comprises data regarding the structure of the event venue 102. The venue model 272 of some embodiments may comprise the information of the venue model 216. The venue model 272 also comprises venue related data necessary for calibration of the sensor data stream.

The sensor data stream 111 generated by the sensor data hub 110 comprises data regarding positional information and lens configuration of each camera 108 positioned to capture images of the events occurring in the event venue 102. The sensor data stream 111 may comprise information regarding the position of camera 108 within or in the immediate vicinity of the event venue 102, camera panning information, camera tilt information, camera focus information, camera zoom information, for example. The sensor data stream 111 comprises information to allow the determination of the position of the camera 108 with respect to the venue model 272 or venue model 274 and simulation of a virtual camera corresponding to the camera 108 in the event venue model 272 or venue model 274.

A sensor data calibration module 230 calibrates the sensor data stream 111 to better correspond with the venue model 272 or venue model 274 to thereby improve the accuracy of the simulation of a virtual camera corresponding to the camera 108, ultimately leading to improvement of the accuracy of the augmentation instruction stream 119. In some embodiments, a part or whole of the calibration may be performed by the sensor data hub 110. The calibration of the sensor data stream 111 may involve incorporating precise measurements of where the camera 108 is in relation to a pre-defined axis point in the venue model 272 or venue model 274 and determination of the tilt and pan of camera 108 with respect to the venue model 272 or venue model 274. In some embodiments, the calibration of the sensor data may be a one-time process, which may be performed when the broadcast overlay generation system 100 is deployed at an event venue. In some embodiments, the calibration of the sensor data may be performed in response to changes in the position or location of camera 108.

After calibrating the sensor data stream 111, an augmentation instruction generation module 248 combines the processed event data stream 117 with the calibrated sensor data stream to generate an augmentation instruction stream 119. The augmentation instruction stream 119 may be transmitted to one or more overlay rendering engines 120 to generate overlay graphics based on the augmentation instruction stream 119. The augmentation instruction stream 119 may comprise data in a format that is portable across multiple overlay rendering engines 120 incorporating different rendering graphics or different rendering engines. Accordingly, the augmentation instruction stream 119 allows the scaling or parallelisation of the overlay rendering processes performed by the overlay rendering engine 120, providing greater production or directorial flexibility using the common augmentation instruction stream 119. The ability to support multiple overlay rendering engines 120 may be relevant when distinct overlays need to be generated for distinct broadcast target audiences, such as for different geographical regions, where the augmented video stream 121 may be broadcast.

The broadcast overlay rendering engine 120 comprises at least one processor 238 in communication with a network interface 236 and a memory 240. Memory 240 comprises the venue model 274 comprising metadata and data regarding fixtures and sports artefacts present in the event venue 120. Venue model 274 may comprise the data of venue models 216 and/or venue model 272. Venue model 274 also comprises additional metadata regarding the event venue necessary to perform rendering, overlay graphic generation and overlay graphic compositing operations. The memory 240 also comprises a rendering engine, such as a game engine, that comprises program code to process the unaugmented video stream 109 generated by camera 108 and generate an augmented video stream 121 based on the augmentation instruction stream 119. The rendering engine 242 may comprise program code modules, libraries, program code dependencies, metadata and APIs for generating composite images and rendering graphics in composite images to produce images augmented with overlay graphics. The rendering engine 242 may comprise an overlay graphics generation module 232 and an overlay graphics compositing module 234.

The overlay graphics generation module 232 processes the augmentation instruction stream 119 and the unaugmented video stream 109 to generate overlay graphics. The overlay graphics are generated by simulating the placement of a virtual camera in the venue model 274 based on the calibrated sensor data and generating graphics based on the event data stream 117 in the simulation. By using the calibrated sensor data, a virtual camera in the venue model 274 may be accurately simulated and the position of overlay graphics in the broadcast image stream may be accurately generated in response to the event data stream 117. In the simulation, the virtual camera accurately generates overlay graphics to correspond with the line of sight, focus and zoom configuration of the camera 108 based on the calibrated sensor data.

The memory 240 of the overlay rendering engine 120 may comprise an overlay graphics definition library 250. The overlay graphics definition library 250 may comprise a catalogue or collection of predefined overlay graphics associated with each category of an event that may potentially occur in the event venue 102. Each predefined graphic may be defined using a set of graphics parameters. The graphics parameters may include, for example, a graphics size value, a graphics scale value, a graphics colour value, a graphics animation definition, a graphics orientation or pattern value, a graphics display persistence timing value, a graphics texture value, and/or a graphics transparency value. In an embodiment where the rendering engine 242 is based on a version of the Unreal Engine™ each graphics overlay defined in the overlay graphics definition library 250 may be defined using a skeletal mesh or a static mesh asset content type, for example. A static mesh may comprise a geometry defined using a set of polygons to define an overlay graphic. A skeletal mesh may comprise a set of polygons composed to make up the surface of the skeletal mesh and a hierarchical set of interconnected bones which may be used to animate the vertices of the polygons defining the overlay graphic.

The overlay graphics generated by the overlay graphics generation module 232 are subsequently processed by the overlay graphics compositing module 234. The overlay graphics compositing module 234 processes the generated overlay graphics to identify which portions of the generated overlay graphics should be hidden and which parts of the overlay graphics should be presented along with the event image stream to be transmitted by broadcast transmission system 122. This determination is made by the graphics compositing module 234 based on the metadata present in the venue model 274 and the data in the event data stream 117.

Some parts of the generated overlay graphics may obscure foreground objects such as players or sports artefacts or venue markings in an image of the event venue 102. In some embodiments, the generated overlay graphics may obscure a single foreground object. In some embodiments, the generated overlay graphics may obscure a plurality of foreground objects. For example, an overlay graphic for a tennis broadcast relating to a bounce spot of a ball may obscure a part of the image corresponding to a player if the player is positioned between camera 108 and the determined bounce spot in the event venue 102. The overlay graphics compositing module 234 assesses each element of the overlay graphics generated by the overlay graphics generation module 232 and data regarding the position of foreground objects such as players or artefacts present in the event data stream 117 and the venue model 274 to determine which elements of the generated overlay graphics should be hidden to avoid the obfuscation of objects of interest or foreground objects in the unaugmented video stream 109 generated by camera 108. In some embodiments, matting and chroma key compositing techniques may be implemented by the overlay graphics compositing module 234.

FIG. 3 illustrates a flowchart of a method 300 for processing event data generated by the event data generation system 116. The method 300 is performed by the event data analysis system 116. At step 302, unprocessed event data is received by the event data analysis system 116. In some embodiments, the event data analysis system 116 may receive the unprocessed event data from an event data generation system 114 located in close proximity to the event venue 102. In other embodiments, parts of the event data generation system 114 may be located remote to the event venue and the unprocessed event data may be received over a computer network, such as the internet, provided latency is kept low enough to provide the overlays in near real-time.

At step 304, the event data filter module 218 processes the unprocessed event data to filter elements of the event data not relevant for the generation of overlay graphics. The unprocessed event data may relate to a wide variety of events occurring in the event venue that are not relevant for the generation of overlay graphics. The code provided in the event data filter module 218 identifies the relevant event data with reference to predefined flags, or metadata tags in the unprocessed event data.

At 306, the filtered event data is processed by the object attribute determination module 220 to determine one or more object attributes. The object attributes may relate to a position information of an object (i.e. a set of image frame coordinates to define the bounds and/or centroid of the object), or a kinetic attribute of the object such as speed or velocity, an orientation attribute of the object, or a future or projected position or speed or location of an object, for example. The object attribute may also relate to a player in the event venue 102. Object attributes related to a player may include, a player's location or position (e.g. defined by a centroid of the player), a players speed or direction of movement, a player's projected or future position within the event venue 102, for example. In some embodiments, the object attributes may relate to a future or projected event. The object attributes related to a future or projected event may be determined based on a kinetic analysis of the filtered event data available until a point in time. The kinetic analysis may include an analysis of a path of an object, such as a projectile or ball, based on information regarding the velocity of the object obtained from the filtered event data.

At 308, the overlay trigger module 222 processes the determined object attributes including object attributes relating to future or projected events to determine whether one or more predefined trigger conditions to initiate the generation of an overlay graphic have been satisfied. If at least one of the predefined trigger conditions has been satisfied, then at 310 the processed and filtered event data including the determined object attributes are transmitted as a processed event data stream 117 to the event data augmentation system 118.

An overlay trigger module 222 in memory 214 comprises program code embodying logic or instructions or a set of rules to identify events in response to which generation of an overlay must occur. The event data generation system 114 may generate unprocessed event data 115 corresponding to a large number and variety of events occurring in the event venue 102. However, not all events occurring in the event venue 102 may be of interest for generating overlays. A latency of the method 200 referred to as an event data processing latency may be in the range of 5 ms to 15 ms.

Various parameters defining the one or more triggers in the program code of the overlay trigger module 222 may be configurable in some embodiments. The configuration of the various parameters defining the one or more triggers may allow definition or calibration of triggers to suit different overlay graphic production needs. Since a significant number of events may occur in the event venue 102, the configuration of the parameters defining the one or more triggers may allow selection of a specific subset of events for the generation of overlay graphics. The object attribute data identified by the overlay trigger module 222 may constitute an overlay element definition. The overlay element definition may comprise an image location or image coordinates associated with a position where the overlay element is to be displayed in one image or successive images of the broadcast image stream, a type identifier for the overlay element, and other attributes defining a nature of the overlay element. The overlay element definition may allow extraction of graphics related to the overlay element from the graphics definition library 250.

In some embodiments, the steps of method 300 may be executed automatically in sequence. In some embodiments, some, or all, of the steps of method 300 may be executed without intervening steps. For example, some, or all, of the steps of method 300 may be executed without intervening steps that require an amount of time that would degrade the real time or near real time appearance of the broadcast overlay, such as 5 ms to 10 ms or 5 ms to 20 ms.

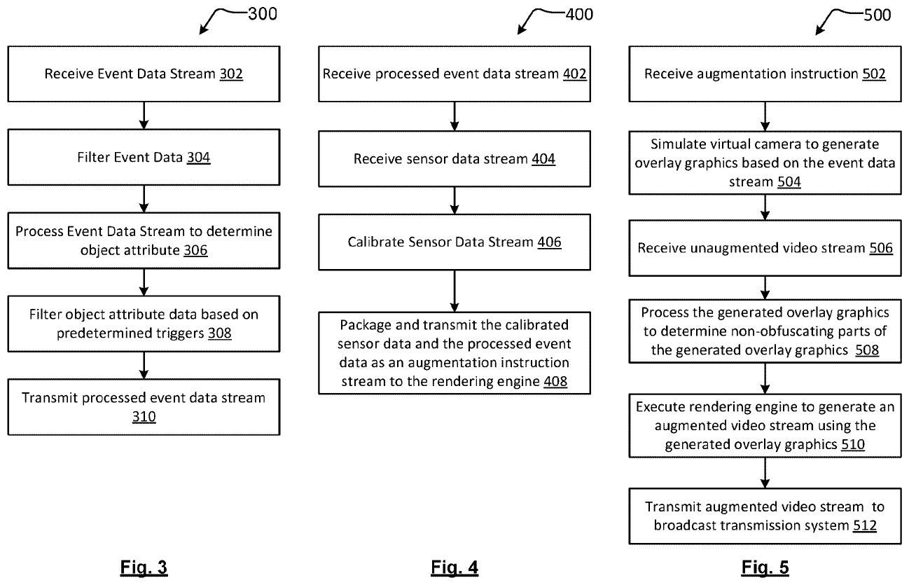

FIG. 4 illustrates a flowchart of a method 400 for generating overlay augmentation instructions 119 by the event data augmentation system 118 according to some embodiments. At 402, the processed event data stream 117 is received by the event data augmentation system 118. The processed event data stream 117 comprises filtered event data and object attribute data that relates to at least one overlay graphic.

At 404, the event data augmentation system 118 receives the sensor data stream 111 from the sensor data hub 110. The sensor data stream 111 generated by the sensor data hub 110 comprises data regarding positional information and lens configuration of each camera 108 positioned to capture images of the events occurring in the event venue 102. The sensor data stream 111 may comprise information regarding the position of camera 108 within the event venue 102 or in the vicinity of the event venue 102, camera panning information, camera tilt information, camera focus information, camera zoom information, for example. The sensor data stream 111 comprises information to allow the determination of the position of camera 108 with respect to the venue model 272.

Steps 402 and 404 may be performed in parallel to improve the overall performance and reduce the latency of the generation of the augmentation instruction stream 119.

At step 406, the sensor data calibration module 230 calibrates the sensor data stream 111 to better correspond with the venue model 272 to thereby improve the accuracy of the augmentation instruction stream 119. In some embodiments, a part or whole of the calibration may be performed by the sensor data hub 110. The calibration of the sensor data stream 111 may involve incorporating precise measurements of where the camera 108 is positioned in relation to a pre-defined axis point in the venue model 272 and determination of the tilt and pan of camera 108 with respect to the venue model 272. In some embodiments, the calibration of the sensor data may be a one sensor data stream 111 or may be a one-time process which may be performed when the broadcast overlay generation system 100 is deployed at an event venue 102. In some embodiments, the calibration of the sensor data may be performed in response to changes in the position or location of camera 108. Steps 402 and 406 may be performed in parallel to improve the overall performance and reduce the latency of the generation of the augmentation instruction stream 119.

At 408, the calibrated sensor data stream and the received processed event data stream 177 are packed into an augmentation instruction stream 119 by the augmentation instruction generation module 248. The augmentation instruction stream 119 may be transmitted to one or more overlay rendering engine 120 to generate overlay graphics based on the augmentation instruction stream 119.

In some embodiments, the steps of method 400 may be executed automatically in sequence. In some embodiments, some, or all, of the steps of method 400 may be executed without intervening steps. For example, some, or all, of the steps of method 400 may be executed without intervening steps that require an amount of time that would degrade the real time or near real time appearance of the broadcast overlay, such as 5 ms to 10 ms or 5 ms to 20 ms.

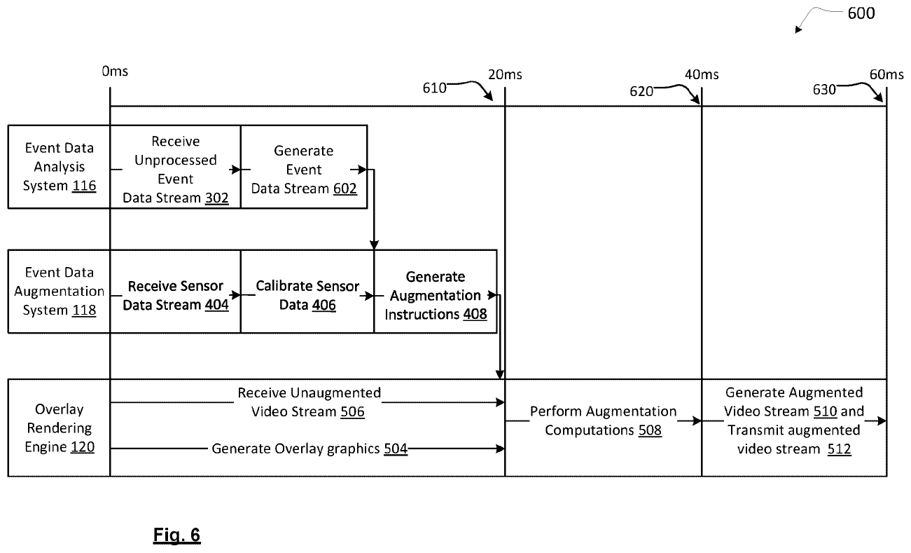

FIG. 5 illustrates a flowchart of a method 500 for generating the augmented video stream 121 by the overlay rendering engine 120 according to some embodiments. At step 502, the overlay rendering engine 120 receives the augmentation instruction stream 119. The unaugmented video stream 109 corresponds to the raw video of events occurring in the event venue 102 captured by camera 108.

At step 504, the overlay graphics generation module 232 processes the event data stream and the calibrated sensor data to generate overlay graphics. The overlay graphics are generated by simulating the placement of a virtual camera in the venue model 274 based on the calibrated sensor data and generating graphics based on the event data stream 117 in the simulation. By using the calibrated sensor data, a virtual camera in the venue model 274 may be accurately simulated and overlay graphics may be accurately generated in response to the event data stream 117. In the simulation, the virtual camera accurately generates overlays to correspond with the line of sight, focus and zoom configuration of the camera 108 based on the calibrated sensor data.

At step 506, the overlay rendering engine 120 receives an unaugmented video stream 109 from the camera 108. Steps 506 may be performed in parallel with steps 502 and 504 to reduce the latency of the generation of the augmented video stream 121.

At step 508, the overlay graphics generated by the overlay graphics generation module 232 are processed by the overlay graphics compositing module 234. The overlay graphics compositing module 234 processes the generated overlay graphics in combination with the unaugmented video stream received at 506 to identify which portions of the generated overlay graphics should be hidden and which parts of the overlay graphics should be presented.

This determination is based on the metadata present in the venue model 274 and the data in the event data stream 117, and the images of the unaugmented video stream. Some parts of the generated overlay graphics may obscure objects, players or artefacts in an image of the event venue 102. For example, an overlay graphic for a tennis broadcast relating to a bounce spot of a ball may obscure a part of the image corresponding to a player if the player is positioned between camera 108 and the determined bounce spot in the event venue 102. The overlay graphics compositing module 234 assesses each element of the overlay graphics generated by the overlay graphics generation module 232 and data regarding the position of players or other sports artefacts present in the event data stream 117, the venue model 274 and the and the images of the unaugmented video stream to determine which elements or parts of the generated overlay graphics should be hidden to avoid the obfuscation of objects of interest in the unaugmented video stream 109 generated by camera 108. Step 508 may involve performing a matting image processing operation to identify foreground objects in the images of the unaugmented video stream. In some embodiments, a chroma key technique may be used to identify foreground objects in the images of the unaugmented video stream. For example, if the event venue 102 is a tennis court with a blue court colour, then image regions or pixels in the images of the unaugmented video stream that are blue may be considered as background, and rest of the image may be considered as a foreground.

The determined composited overlay graphics comprising the non-obfuscating parts of the generated overlay graphics are suitable for augmentation with the unaugmented video stream 109. A latency of the method of generating overlay augmentation instructions may be referred to as an overlay augmentation instruction generation latency. The overlay augmentation instruction generation latency may be in the range of 5 ms to 20 ms, for example.

At step 510, the rendering engine 242 processed the determined composited overlay graphics and the unaugmented video stream 109 to generate the augmented video stream 121. Step 510 may include compositing of the unaugmented video stream 109 with the one or more overlays or overlay graphics defined at 506 to render the augmented video stream 121. At step 512, the rendered augmented video stream 121 is transmitted to the broadcast transmission system 122 for large scale broadcast to audiences.

In some embodiments, the steps of method 500 may be executed automatically in sequence. In some embodiments, some, or all, of the steps of method 500 may be executed without intervening steps. For example, some, or all, of the steps of method 500 may be executed without intervening steps that require an amount of time that would degrade the real time or near real time appearance of the broadcast overlay, such as 5 ms to 10 ms or 5 ms to 20 ms.

FIG. 6 illustrates a latency timing diagram 600 of the various processes of the overlay augmentation generation system 100 according to some embodiments. The latency timing diagram illustrates that the various data processing operations performed by the overlay augmentation generation system 100 may be parallelised to reduce the overall latency of the overlay augmentation generation, such that the augmented video stream 121 is generated in near real-time with respect to the event occurring in the event venue. Thus, the latency difference between the unaugmented video stream 109 and the augmented video stream 121 is imperceptible to the human eye.

The exemplary latency timing diagram 600 comprises three checkpoints 610, 620 and 630, each checkpoint corresponding to a 20 ms interval or cycle of processing by the various components of the overlay augmentation generation system 100. In embodiments where the unaugmented video stream 109 is captured at a frame rate of 50 frames per second, the 20 ms interval or cycle of processing may correspond to a period of time associated with the interval (20 ms) between the capture of each subsequent frame. In embodiments where the unaugmented video stream 109 is captured at a frame rate of 60 frames per second, the interval or cycle of processing may correspond to a period of time of 16.6 ms associated with the interval between capture of each subsequent frame.

In other embodiments, the checkpoints 610, 620 and 630 may be located at different time intervals such as around 10 ms, 16 ms, 30 ms, 32 ms, 40 ms, 60 ms, 64 ms, for example. The interval between each of the checkpoints 610, 620 and 630 may not be uniform in some embodiments. The total latency is around 60 ms in embodiments where three 20 ms checkpoint intervals are employed, for a frame rate of 50 frames per second, such as is illustrated in FIG. 6. For embodiments where the frame rate is 60 frames per second, the total latency is around 50 ms, including three 16.6 ms checkpoint intervals. However, in other embodiments, the total latency may vary between around 20 ms and around 120 ms, optionally around 30 ms to around 120 ms, optionally around 40 ms to around 100 ms, optionally around 50 ms to 90 ms, optionally around 32 ms to around 64 ms, optionally around 48 ms to around 96 ms, depending on the latency of each checkpoint interval. Although 20 ms total latency would be difficult to achieve because of processing limits with current rendering technology and frame rate of camera technology, such low latency may be more easily achieved with future rendering and camera technology. The checkpoints serve as points in time at which the various components of the overlay augmentation generation system 100 sync with each other and initiate the next stage of processing for generation of the augmented video stream 121.

As illustrated by the latency timing diagram 600, the event data analysis system 116 and the event data augmentation system 118 perform some operations in parallel. Step 602 of generating the event data stream corresponds to the steps 304 to 308 of the method 300 of FIG. 3. The processed event data stream 117 is received by the event data augmentation system 118 before the augmentation instructions are generated at step 408. The generated augmentation instruction stream 119 is received by the overlay rendering engine in parallel with step 506 of receiving the unaugmented video stream and step 504 of generating overlay graphics. With both the unaugmented video stream 109 and the augmentation instruction stream 119 received by checkpoint 610, the overlay rendering engine 120 has all the necessary input to perform step 508 including the various augmentation computation including compositing, matting or chroma keying to generate the non-obfuscating overlay graphics before the checkpoint 620. In some embodiments, step 504 may be completed before checkpoint 610. The augmented video stream 121 may be generated after checkpoint 620 through step 510 executed by the rendering engine 242. The generated augmented video stream 121 may be subsequently transmitted to the broadcast transmission system 122 at step 512 performed before the checkpoint 630.

In some embodiments, the operations shown and described in relation to the latency timing diagram 600 may be executed automatically. In some embodiments, some, or all, of the operations shown and described in relation to the latency timing diagram 600 may be executed without intervening steps or processes.

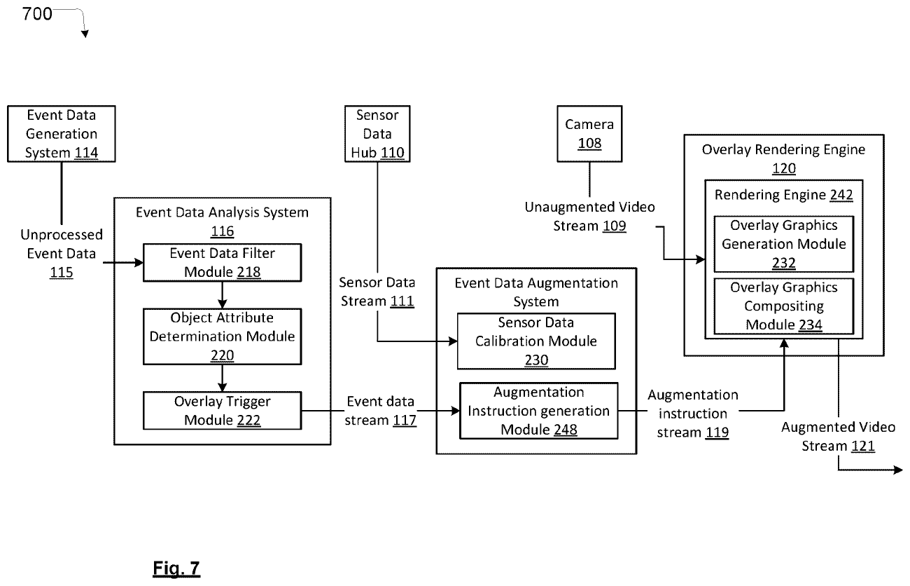

FIG. 7 is a dataflow diagram 700 showing the path of data streams as they are processed by the various logical and physical components of the system for generating overlays for a broadcast according to some embodiments, In the dataflow diagram 700, various logical components of the event data analysis system 116, the event data augmentation system 118 and the overlay rendering engine 120 have been reproduced and the path taken in processing of the unprocessed event data stream 115, the sensor data stream 111 and the unaugmented video stream 119 has been identified with respect to the various logical components to produce the augmented video stream 121.

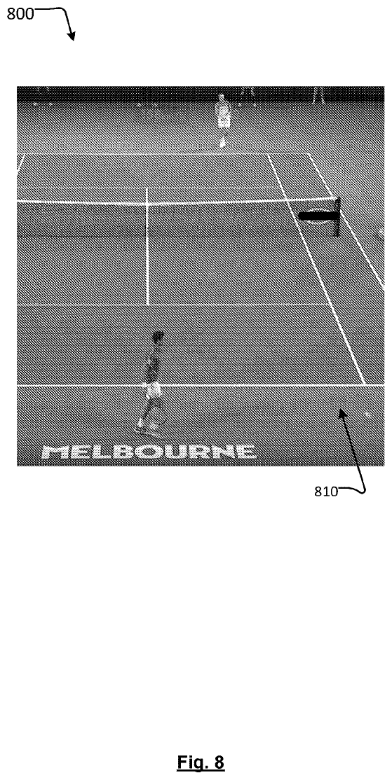

FIG. 8 illustrates an image 800 forming part of an augmented broadcast transmission according to some embodiments. Image 800 comprises an overlay graphic 810 in the form of an oval-shaped spot mark corresponding to a point or region in the event venue where the ball had bounced on the court. The overlay graphic may have a specific colour to represent the nature of the event. For example, the overlay graphic 810 may be coloured red to indicate that the ball bounced outside of the court markings.

FIG. 9 illustrates another image 900 forming part of an augmented broadcast transmission according to some embodiments. Image 900 comprises an overlay graphic 910 that highlights a portion of the net region, such as a top portion or the net headband, to indicate that a particular event, namely a double fault has occurred. Additionally, image 900 also comprises overlay graphic 920 indicating a serve speed and overlay graphic 930 positioned along a length of the net, indicating to a viewer that a double fault has occurred. In some embodiments, overlay graphics 910, 920, and 930 may have specific colours to represent or highlight the nature of the event. For example, overlay graphic 910 may be coloured red to indicate that a double fault has occurred.

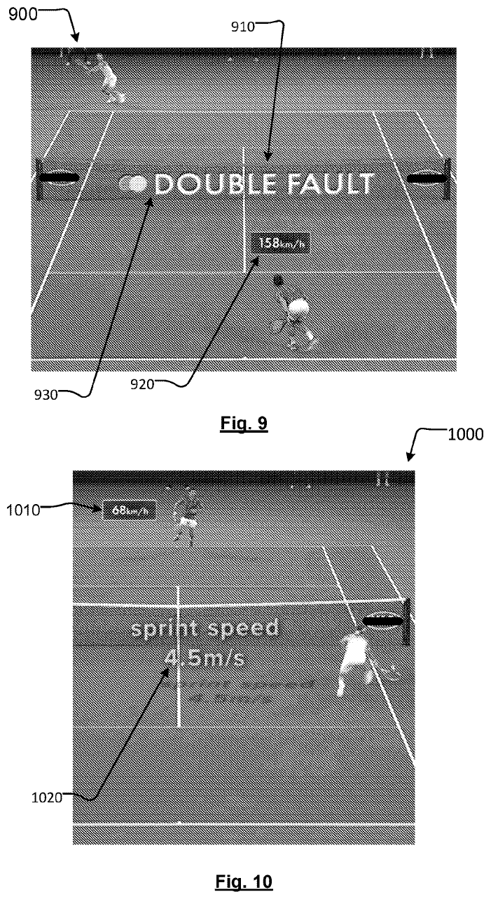

FIG. 10 illustrates another image 1000 forming part of an augmented broadcast transmission according to some embodiments. Image 1000 comprises an overlay graphic 1010 that indicates a speed of the ball after being hit. Additionally, image 1000 also comprises overlay graphics 1020 indicating a sprint speed of a player. Overlay graphics may be shown with a projected shadow onto a ground, court or other surface. For example, overlay graphic 1020 is shown with the words “sprint speed 4.5 m/s” overlaid to seeming float in the air above the court surface, while the same words are shown by a shadow effect projected onto the court surface. Both the return speed and the sprint speed are object attributes determined by the object attribute determination module 220 at step 306 of the flowchart of FIG. 3. In some embodiments, overlay graphics 1010 and 1020 may have specific colours to represent or highlight the nature of the event. For example, all or part of overlay graphic 1010 may be coloured yellow to indicate the sprint speed of a player.

FIG. 11 illustrates another image 1100 forming part of an augmented broadcast transmission according to some embodiments. Image 1100 comprises an overlay graphic 1110 in the form of a spot corresponding to a point or region in the event venue where the ball bounced. The overlay graphic 1110 may be green in colour to indicate that it was a valid shot. An overlay graphic 1120 corresponding to a concentric circle around the ball and an overlay graphic 1130 is in the form of a segment connecting a player's racquet and the ball. The overlay graphic 1130 may be coloured green to indicate that the ball may prospectively be returned. In some embodiments, the overlay graphic 1120 may be coloured white and/or green to indicate that the ball may prospectively be returned.

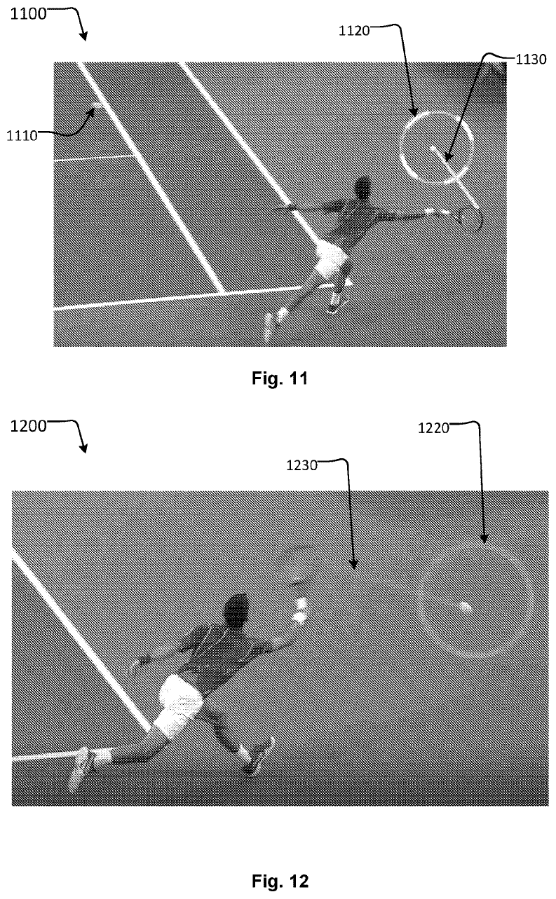

FIG. 12 illustrates another image 1200 forming part of an augmented broadcast transmission according to some embodiments. Image 1200 is in a series of images captured immediately after image 1100. Similar to image 1100, image 1200 comprises an overlay graphic 1220 corresponding to a concentric circle around the ball and an overlay graphic 1230 is in the form of a segment connecting a player's racquet and the ball. Unlike the overlay graphics 1120, 1130 of FIG. 11, the overlay graphics 1220 and 1230 may be coloured red to indicate that a shot has been missed by the player.

FIG. 13 is an example of an image 1300 from the unaugmented video stream 109 according to some embodiments. Data corresponding to image 1300 may be received by the overlay rendering engine 120 at step 506 of FIG. 5. Similarly, event data corresponding to events that occurred immediately before the image 1300 was captured may be received by the event data analysis system 116 at step 302 of FIG. 3. Visible in image 1300 are players 1305 and 1315, a net 1310 and court marking 1320.

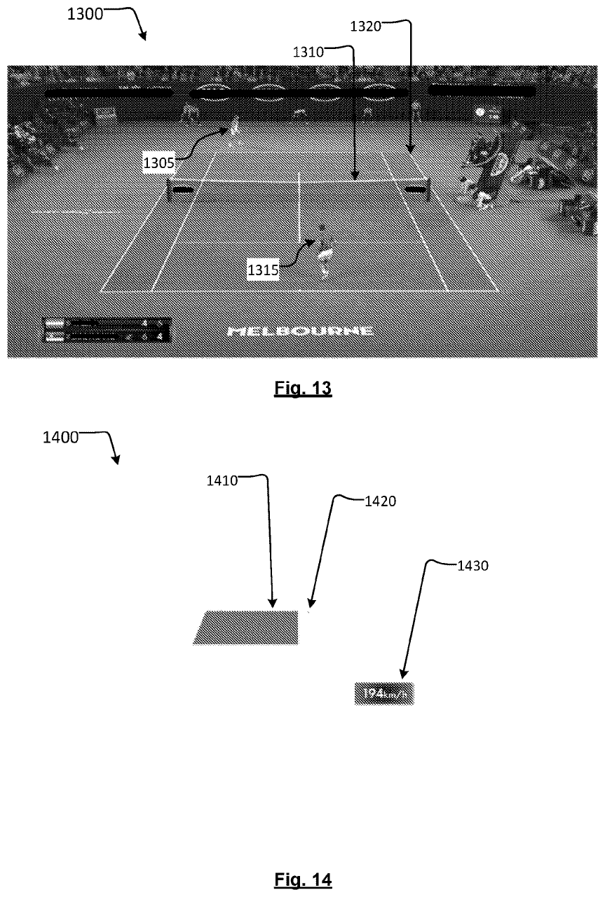

FIG. 14 is an example of an image 1400 comprising overlay graphics 1410, 1420, 1430 generated based on event data associated with the event of an invalid serve that occurred immediately before the image 1300 was captured by camera 108. The overlay graphics of image 1400 may be generated as an outcome of step 504 of FIG. 5. The overlay graphic 1410 shades over a valid serving region of the court. The overlay graphic 1410 is red to indicate an invalid serve. The overlay graphic 1420 is a spot indicating where the served ball had bounced. The overlay graphic 1420 is also red to indicate an invalid serve. The overlay graphic 1430 includes a serve speed information determined at the object attribute determination step 306 of FIG. 3. In some embodiments, overlay graphics 1410 and 1420 may be a different colour, such as green, to indicate a valid serve, for example.

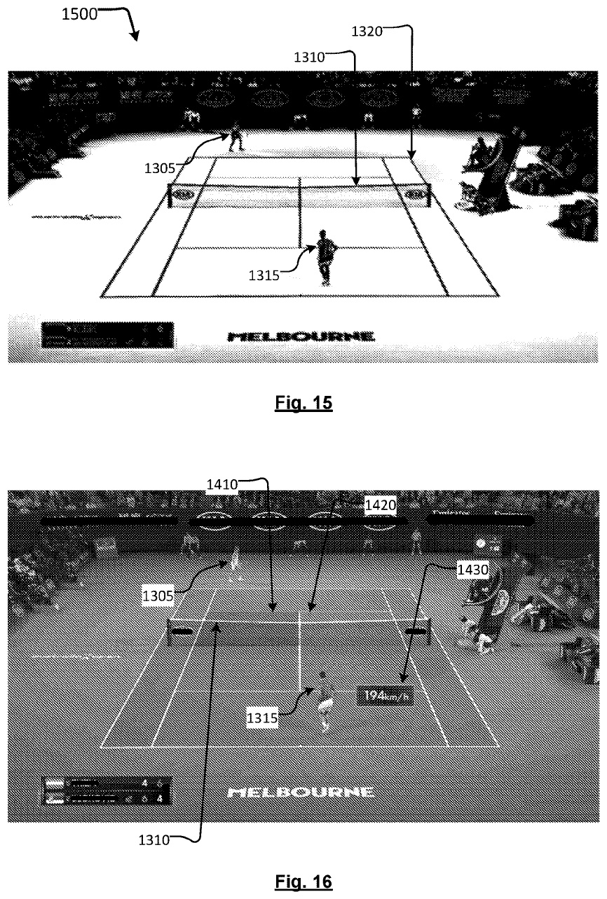

FIG. 15 is an image 1500 generated by performing a matting image processing operation on the image 1300 of FIG. 13. The matting image processing operation may be performed as part of step 506 of FIG. 5 to determine non-obfuscating parts of the overlay graphics of image 1400. The matting image processing operation comprises extracting foreground objects or objects of interest from an image. The matting image processing operation may be performed by the rendering engine 242. As is visible in image 1500, the players 1305, 1315, the net 1310 and the court marking 1320 has been identified with a dark black colour indicating that they are foreground objects that should not be obfuscated by the overlay graphics of FIG. 14. As part of step 508 of FIG. 5, pixels or image regions corresponding to the overlay graphics of image 1400 that overlap with the foreground objects identified in image 1500 may be identified as obfuscating parts of the overlay graphic. The pixels or image regions corresponding to the obfuscating parts of the overlay graphics of image 1400 may be made transparent or may be removed altogether from the generated overlay graphics before the execution of step 510 by the rendering engine 242 to generate an augmented video stream 121.

FIG. 16 illustrates an image 1600 generated by compositing the overlay graphics of FIG. 14 in the image of FIG. 13. Image 1600 may be generated at step 510 of FIG. 5 after identifying the non-obfuscating parts of the overlay graphics of image 1400 using the foreground objects identified in FIG. 15. As is visible in image 1600, the part of the overlay graphic 1410 that overlaps with the net portion 1310 has been made transparent or eliminated to avoid obfuscation of the net portion 1310 by the overlay graphic 1410.

Image 1600 shown in FIG. 16 forms part of an augmented broadcast transmission according to some embodiments. Image 1600 comprises the overlay graphic 1410 in the form of a shading covering a marked region of the event venue. Image 1600 also comprises an overlay graphic 1420 in the form of an oval-shaped spot mark corresponding to a point or region in the event venue where the ball has bounced. The combination of overlays 1410 and 1420 indicate to a viewer that the ball has bounced outside of the designated service area. Also observable in image 1600 is a discontinuity in the overlay 1410 associated with an opaque part of the net portion 1310. The discontinuity in overlay 1410 may be determined at step 508 of the flowchart of FIG. 5 by the overlay graphics compositing module 234. Image 1600 also comprises the overlay graphic 1430 in the form of text and graphic positioned near one of the players 1315 to indicate a speed at which the ball was served. The ball speed may be determined based on the unprocessed event data stream 115 at step 306 of the flowchart of FIG. 3.

The processors 212, 226 and 238 are the principal operating part of the respective computer systems. The processors 212, 226 and 238 comprise an ALU (arithmetic and logic unit) and a control unit (CU). An ALU typically processes two input values and produces a single output result. The processing may comprise common arithmetic operations, the common logic operations, and shift operations. The CU is a portion of the processor that contains the necessary registers, counters, and other elements to provide the functionality required to control the movement of information between the memory, the ALU, and other portions of the respective computer systems.

The control unit may contain a program counter, an address register, and a register that contains and decodes the operation code. The latter two registers are sometimes jointly called the instruction register. This control unit may operate a two-step fetch-execute cycle. In the fetch step, the instruction is obtained (fetched) from memory and the decoder determines the nature of the instruction. If it is a memory reference instruction, the execute step carries out the necessary operation(s) and memory reference(s).

The control unit may contain additional registers such as index registers, arithmetic units to provide address modifications, registers, stacks, or pipelines to contain forthcoming instructions and other functional units. Control units of some embodiments may contain specialized hardware that allows for parallel processing of instructions that are issued sequentially.

The processors 212, 226 and 238 may be implemented using one or more microprocessors. A microprocessor is a semiconductor chip, or chipset, that implements the central processor of a computer. In some embodiments, the processors 212, 226 and 238 may be implemented using a computing chip containing more than one central processor or ‘core’. The various cores each have local memory and cache and communicate internally via a common data bus, which itself is connected via a second, larger cache to the components outside of the core. In some embodiments, the processors 212, 226 and 238 may be implemented using one or more graphics processing units (GPUs). The GPU comprises hardware and circuitry to rapidly manipulate and alter memory to accelerate the creation or manipulation of image data in an image frame buffer.

In some embodiments, the methods and/or processes, as described herein, may utilise divided performance. That is, multiple computing systems, or computing devices, or computer servers, or other technology capable of performing the methods and/or processes as described herein may be utilised. For example, a first part of a method may be performed on a first server, and a second part of the method performed on a second server, where the combination of the first part and second part amount to the method as a whole.

The various data streams referred to in the description may comprise a series of packets of data comprising encoded information transmitted over various wired or wireless communication channels. Each packet in each data stream may also comprise metadata information such as a timestamp at which it was generated, a source that generated that packet and one or more configuration parameters associated with the source of the data in the packet.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. A method for generating overlay graphics for a broadcast transmission, the method comprising:
receiving a broadcast transmission stream of an event from a camera, the broadcast transmission stream comprising a series of images;
receiving a stream of event data corresponding to the series of images, the stream of event data comprising object information regarding an object in the series of images;
defining an overlay element based on the stream of event data, the overlay element being associated with the object in the series of images;
augmenting the broadcast transmission with the overlay element to generate an augmented broadcast transmission, the augmented broadcast transmission comprising the series of images overlayed with the overlay element;
wherein a latency between receiving the broadcast transmission stream and generating the augmented broadcast transmission is imperceptible to the human eye.

2. The method of claim 1, further comprising receiving a camera sensor data stream corresponding to the camera, the camera sensor data stream comprising camera position, orientation and focus data.

3. The method of claim 2, wherein generating the augmented broadcast transmission is based on processing the camera sensor data stream to simulate a virtual camera in a virtual model of the event venue using the camera sensor data stream.

4. The method of claim 1, wherein the method further comprises processing the stream of event data to filter event data to select event data relevant to the definition of the overlay element.

5. The method of claim 3, further comprising processing the stream of event data to determine an object attribute.

6. The method of claim 5, wherein the object attribute comprises any one or more of:
an object position information within the virtual model of an event venue, or
an object velocity, or
an object orientation.

7. The method of claim 5, wherein the determined object attribute comprises a projected object path in the event venue.

8. The method of claim 5, wherein the overlay element is generated based on the determined object attributes and a predefined trigger condition.

9. The method of claim 8, wherein the predefined trigger condition comprises a threshold relating to the object attribute to determine the generation of the overlay element.

10. The method of claim 1, further comprising processing the series of images to determine a foreground object in the series of images.

11. The method of claim 10, wherein defining the overlay element based on the stream of event data further comprises determining whether the overlay element obfuscates the foreground object in the series of images,
on determining that the overlay element obfuscates the foreground object in the series of images, modifying the overlay element to not obfuscate the foreground object.

12. The method of claim 10, wherein the foreground object comprises a person or a venue artefact.

13. The method of claim 5, wherein defining the overlay element based on the stream of event data further comprises determining a display position of the overlay element within the series of images, wherein the display position is based on the determined object attribute.

14. The method of claim 1 where the object may include any one of:
a sports projectile,
a person, or
a venue artefact.

15. The method of claim 5, wherein the processing of the stream of event data to determine the object attribute and the simulation of the virtual camera is performed in parallel.

16. The method of claim 1, wherein the augmenting of the broadcast transmission with the overlay element is performed by a graphics rendering engine.

17. The method of claim 10, wherein determination of the foreground object in the series of images is performed using matting image processing operations.

18. A method for generating broadcast augmentation instructions, the method comprising:
receiving a stream of event data corresponding to a series of images in a broadcast transmission stream, the stream of event data comprising object information regarding an object in the series of images;
receiving a camera sensor data stream corresponding to a camera, the camera sensor data stream comprising data defining a camera position, a camera orientation and camera focus data;
processing the stream of event data using a set of rules to trigger an overlay element definition;
generating broadcast augmentation instructions suitable for a graphics rendering engine, the broadcast augmentation instructions comprising instructions based on the overlay element definition;
wherein a latency between receiving the stream of event data and transmitting the broadcast augmentation instructions is imperceptible to the human eye.

19. A method for generating overlays for broadcast transmission, the method comprising:
receiving a broadcast transmission stream of an event from a camera, the broadcast transmission stream comprising a series of images;
receiving a stream of event data corresponding to the series of images, the stream of event data comprising object information regarding an object in the series of images;
defining an overlay element based on the stream of event data, overlay element being associated with the object in the series of images;
augmenting the broadcast transmission with the overlay element to generate an augmented broadcast transmission, the augmented broadcast transmission comprising the series of images composited with the overlay element;
wherein a latency between receiving the broadcast transmission stream and generating the augmented broadcast transmission is in the range of 20 ms to 120 ms.

20. (canceled)

21. The method of claim 19, further comprising receiving a camera sensor data stream corresponding to the camera, the camera sensor data stream comprising camera position, orientation and focus data.

22-57. (canceled)
